(19) United States
(12) Patent Application Publication
(10) Pub. No.: US 2006/0208503 A1
(43) Pub. Date: Sep. 21, 2006

(54) Rotary pawl latch

(75) Inventors: Alan Simchayoff, Warrington, PA (US); Richard B. Langkamp JR., Hemlock, NY (US); D. Dale Turner, Honeoye Falls, NY (US); James H. Vickers, Media, PA (US)

Correspondence Address: PAUL AND PAUL, 2000 MARKET STREET, SUITE 2900, PHILADELPHIA, PA, 19103, US

(73) Assignee: Southco, Inc.

(21) Appl. No.: 11/363,441

(22) Filed: Feb. 27, 2006

Related U.S. Application Data
(60) Provisional application No. 60/657,118, filed on Feb. 27, 2005.

(51) Int. Cl. E05C 3/06

(52) U.S. Cl. 292/216

(57) ABSTRACT

A latch assembly for releasably securing a striker in a rotary pawl latch. The latch assembly includes a housing, a rotary pawl, and an actuator. The housing can have 5 one sidewall having a notch for receiving the striker. A trigger can be pivotally attached to the housing such that the actuator releases the rotary pawl thus opening the latch.

### BACKGROUND OF THE INVENTION

1. Field of Invention

The present invention relates to the field of latch assemblies.

2. Brief Description of the Related Art

Latch assemblies are relied on in many applications for securing items, such as panels together. An important use for latches is in the automotive field, where there is a desire and need to access automotive compartments, such as, for example, passenger compartments of vehicles. Various latches for panel closures have been employed where one of the panels such as a swinging door or the like is to be fastened or secured to a stationary panel, doorframe, or compartment body. Although many latch assemblies are known in the prior art, none are seen to teach or suggest the unique features of the present invention or to achieve the advantages of the present invention.

Thus it will be understood that the latch components used to date have presented a number of drawbacks that typically have left the securing of a striker of a panel more awkward, time-consuming and difficult to install, remove, open, close, latch, and unlatch. In some instances, the selected latch, lock and hinge components have provided shorter than desired service lives and/or a lesser than the desired degree of security by virtue of their being relatively simple to defeat, force, break or bypass. In some instances the latch, lock and hinge components have been too weak to withstand the forces that have been encountered during normal service use (e.g., damage or unintended release has been noted as the result of these components being impacted by cargo that shifts as a pickup truck travels from place to place), or these components have taken on such size and bulk as to project into regions of cargo compartments that should be reserved for cargo.

Rotary latches capture a striker in two axes by rotation of a pawl which is activated by a trigger. There may be freedom of movement between the latch and the striker along the axis of the striker which may be cylindrical. This allows for manufacturing tolerance in the fit between the frame or first member to which the latch is mounted and the door or other second member to which the striker is mounted. In addition, difficulties have been encountered when a striker to which a latch such as a rotary latch is to be secured is off-center with respect to being aligned with a catch for engagement with the striker. There are instances when it is not practical to insure that tight tolerances will be maintained in door or frames such that the striker will always fall into the notch or mouth of the latch. The reason for misalignment between the latch and striker can be manufacturing and assembly tolerances, expansion and contraction of the structure due to environmental conditions, shifting of components due to wear during use or distortion of components due to abuse.

### SUMMARY OF THE INVENTION

The invention addresses the foregoing and other needs and drawbacks of the prior art by providing a latch that is particularly well suited for engaging strikers which are off-center, characterized by novel features that also have other applications.

In accordance with another aspect of the preferred practice of the present invention, a rotary latch is provided to releasably latch strikers connected to a door or panel. The housings of these latch may be modified as needed to provide mounting surfaces that carry slotted holes or other mounting formations that can cooperate with mounting hardware such as threaded fasteners to mount the rotary latch in a manner that will allow for adjustment of the positioning of the latch so the latch will function properly. A trigger of the rotary latch of the present invention can be operated by a user, a rod, a cable or another member.

The striker assembly of the present invention allows for movement or float of the striker in the direction perpendicular to the axis of the striker. Further, the bolt of the striker assembly is urged to return to the center position when the striker is released from the latch. This centering position is desired so that the striker will be in position to engage the latch during the next engagement of the striker with the latch even if the striker and latch do not line up exactly for engagement.

The present invention is directed to a rotary latch system for securing the latch to a striker. The present invention includes a housing, a rotary pawl, an actuator, and a trigger means for releasing a striker when the latch is in a closed configuration. The pawl is pivotally attached to the housing and is rotationally movable between a closed or engaged configuration and an open or disengaged configuration. The latch can also have an intermediate position in which a striker can be held by the engagement of the rotary pawl with the actuating means both of which can be provided with a biasing means.

When a striker engages a portion of the rotary pawl the pawl is rotated such that pawl teeth engage actuator teeth. The teeth can be dimensioned and configured such that an intermediate engaging position is attained by the latch and the striker is held in position or if more force is applied a closed or latch configuration is achieved in which the striker will not be released from the latch until the trigger releases the pawl.

The rotary pawl can be made from three joinable plates for ease of assembly. In such a configuration, a striker engagement portion of a protuberance of the rotary pawl which can be made from one plate sweeps an arc which extends further than an actuator engagement portion of the rotary pawl which can be made from two plates which are joinable. The plates can be joined by studs on the plates which fit up to depressions on an adjoining plate. Because striker engagement portion of the protuberance extends further than the actuator engagement portion of the pawl, the latch of the present invention can be of a smaller size as compared to other rotary latches because the pawl teeth can be closer to the pawl pivot point.

The latch of the present invention also has the advantage that the latch can have a single housing side plate which can be fitted interchangeably with the pawl on one side of the housing and the actuator on the other side of the housing.

### BRIEF DESCRIPTION OF THE DRAWINGS

FIG. 1 is an isometric view of the rotary pawl latch according to the present invention shown in the open position receiving a striker.

FIG. 2 is a front side elevational view of the rotary pawl latch of FIG. 1 shown in the open position.

FIG. 3 is an isometric view of the rotary pawl latch according to the present invention shown in an intermediate closed position.

FIG. 4 is a front side elevational view of the rotary pawl latch of FIG. 1.

FIG. 5 is a front side elevational view of the rotary pawl latch of FIG. 1 shown with the rotary pawl of the latch engaging a striker.

FIG. 6 is a front side elevational view of the rotary pawl latch of FIG. 1 shown with the rotary pawl of the latch engaging a striker in an intermediate closed position.

FIG. 7 is a front side elevational view of the rotary pawl latch of FIG. 1 shown with a tooth of the rotary pawl of the latch engaging a tooth on the actuator.

FIG. 8 is a front side elevational view of the rotary pawl latch of FIG. 1 shown in the closed position.

FIG. 9 is a top plan view of the rotary pawl latch of FIG. 1.

FIG. 10 is a sectional view of the rotary pawl latch of the present invention taken along line A-A of FIG. 5 shown with the rotary pawl of the latch engaging a striker.

FIG. 11 is a sectional view of the rotary pawl latch of the present invention taken along line A-A of FIG. 6 shown with the rotary pawl of the latch engaging a striker in an intermediate closed position.

FIG. 12 is a sectional view of the rotary pawl latch of the present invention taken along line A-A of FIG. 7 shown with a tooth of the rotary pawl of the latch engaging a tooth on the actuator.

FIG. 13 is a sectional view of the rotary pawl latch of the present invention taken along line A-A of FIG. 8 shown in the closed position.

FIG. 14 is a sectional view of the rotary pawl latch of the present invention taken along line B-B of FIG. 15.

FIG. 15 is a front view of the rotary pawl latch of the present invention in the closed position.

FIGS. 16 and 17 are exploded views of the latch of the present invention

FIG. 18 is an isometric view of the housing of the latch of the present invention.

FIG. 19 is an isometric view of the striker engagement means of the pawl of the latch of the present invention.

FIG. 20 is a side elevational view of the striker engagement means of the pawl of the latch of the present invention.

FIG. 21 is an isometric view of the actuator engagement means of the pawl of the latch of the present invention.

FIG. 22 is a side elevational view of the actuator engagement means of the pawl of the latch of the present invention.

FIG. 23 is an isometric view of the pawl engagement means of the pawl of the latch of the present invention.

FIG. 24 is a side elevational view of the pawl engagement means of the pawl of the latch of the present invention.

FIG. 25 is an isometric view of a first embodiment of a striker assembly shown with a striker.

FIG. 26 is an exploded view of a first embodiment of a striker assembly of the present invention shown with a striker.

FIG. 27 is an isometric view of the striker assembly of FIG. 26 shown fastened to a first member and the latch of FIG. 1 fastened to a second member and capturing the striker.

FIG. 28 is a side elevational view of the striker assembly of FIG. 26 shown capturing a striker in a centering position.

FIG. 29 is a side elevational view of the striker assembly of FIG. 26 shown capturing a striker in an off-center position.

FIG. 29a is an isometric view of the striker assembly of FIG. 26 shown capturing a striker in a centering position.

FIG. 30 is an isometric view of a second embodiment of a striker assembly of the present invention shown with a striker.

FIG. 31 is an exploded view of the striker assembly of FIG. 30 shown with a striker.

FIG. 32 is a bottom view of the striker assembly of FIG. 30 shown with a striker.

FIG. 33 is an exploded view of a third embodiment of a striker assembly of the present invention shown with a striker.

FIG. 34 is an isometric view of the striker assembly of FIG. 33.

### DETAILED DESCRIPTION OF THE INVENTION

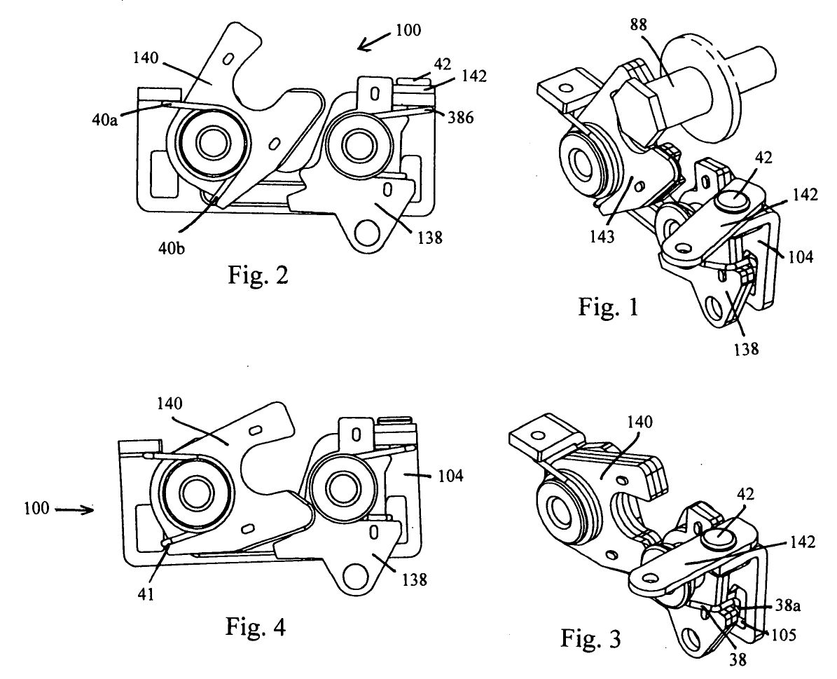

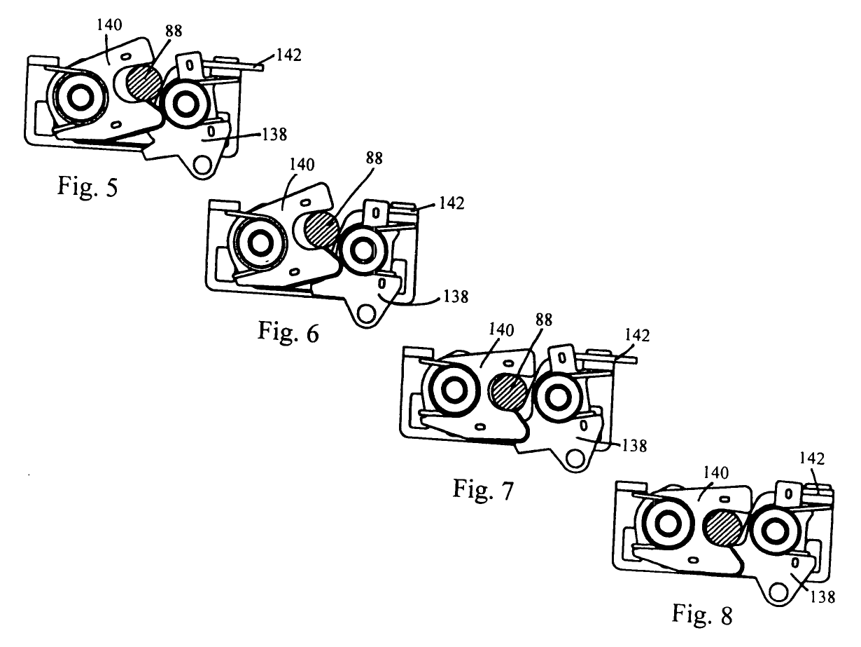

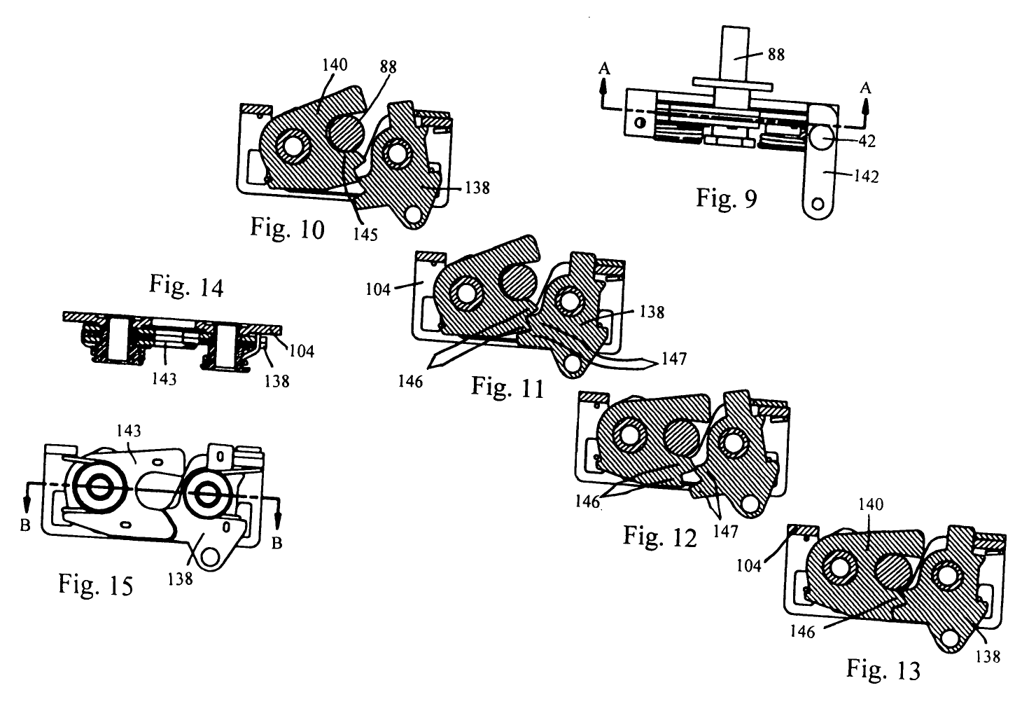

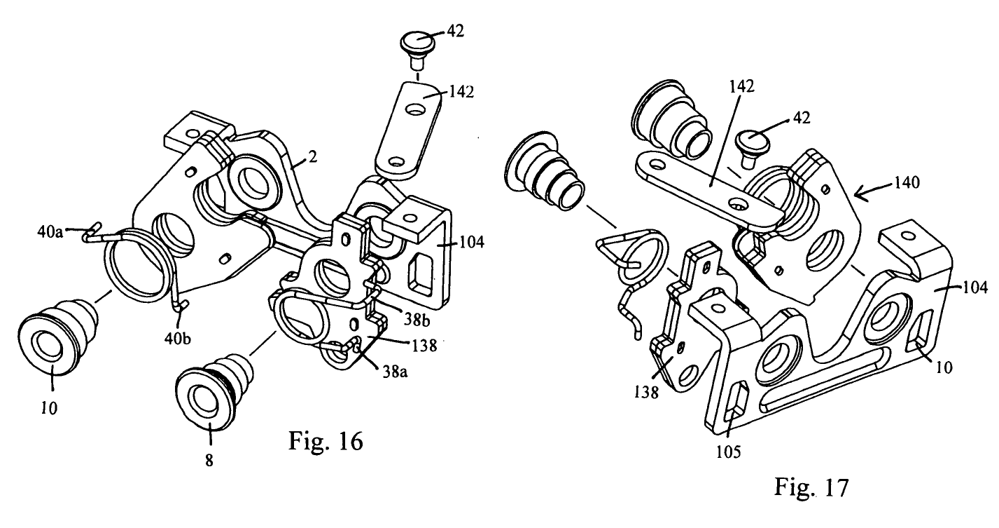

Referring to FIGS. 1-17, a latch 100 made in accordance with the present invention can be seen. The latch 100 includes a latch housing 104 as seen in FIG. 1, a pawl 140, an actuator 138, and trigger means 142 for selectively moving the latch 100 from the closed position in which the latch 100 can be engaging a striker 88. In the illustrated embodiment, trigger 142 is shown in the form of a lever which pivots about trigger pivot means 42 for selectively moving actuator 138 which is acted upon by actuator biasing means 38. Actuator biasing means 38, here a spiral spring has spring leg 38a which engages housing 104 and spring leg 38b which engages cutout 105 in the housing 104. Similarly, pawl biasing means 40, here a spiral spring has spring leg 40a which engages housing 104 and spring leg 40b which engages pawl spring engagement means 41 on pawl 140. Pawl biasing means 40 biases the pawl 140 to the open position while the actuator biasing means 38 biases the actuator 138 in the clockwise direction as seen in FIG. 2.

As seen in FIG. 10, as a striker 88 engages the striker engagement portion 145 of the pawl 140, the pawl 140 rotates such that pawl teeth 146 engage actuator teeth 147. In FIG. 11, the pawl 140 and actuator 138 are engaged by pawl teeth 146 and actuator teeth 147 such that the latch 100 is in an intermediate closed position in which the striker 88 is captured. Further movement as seen in FIG. 12 of the striker 88 results in one of pawl teeth 146 moving past one of actuator teeth 147 such that the latch 100 attains a closed position as seen in FIG. 13.

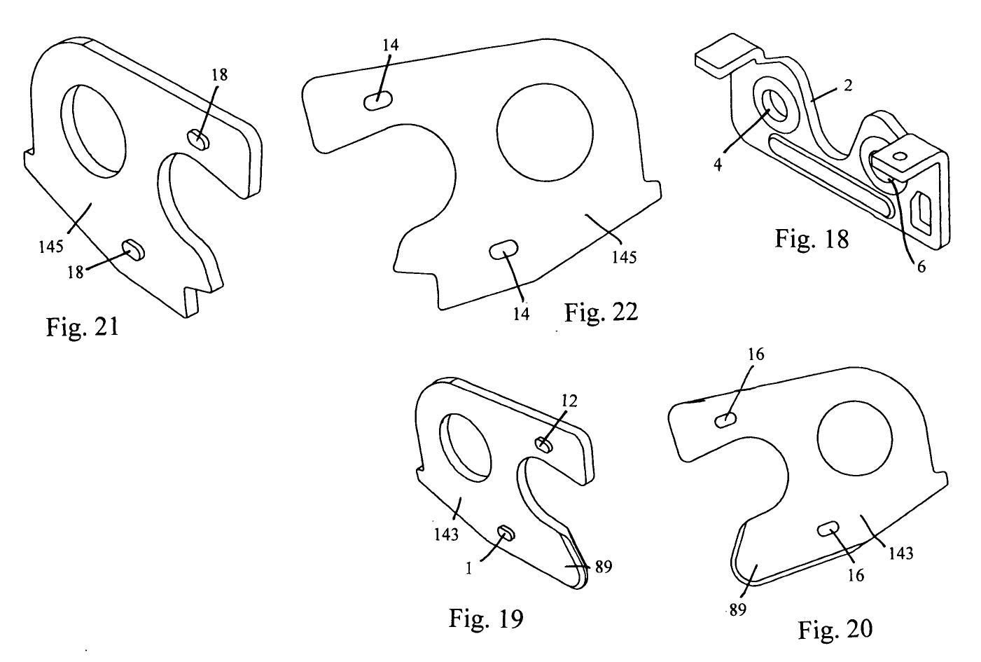

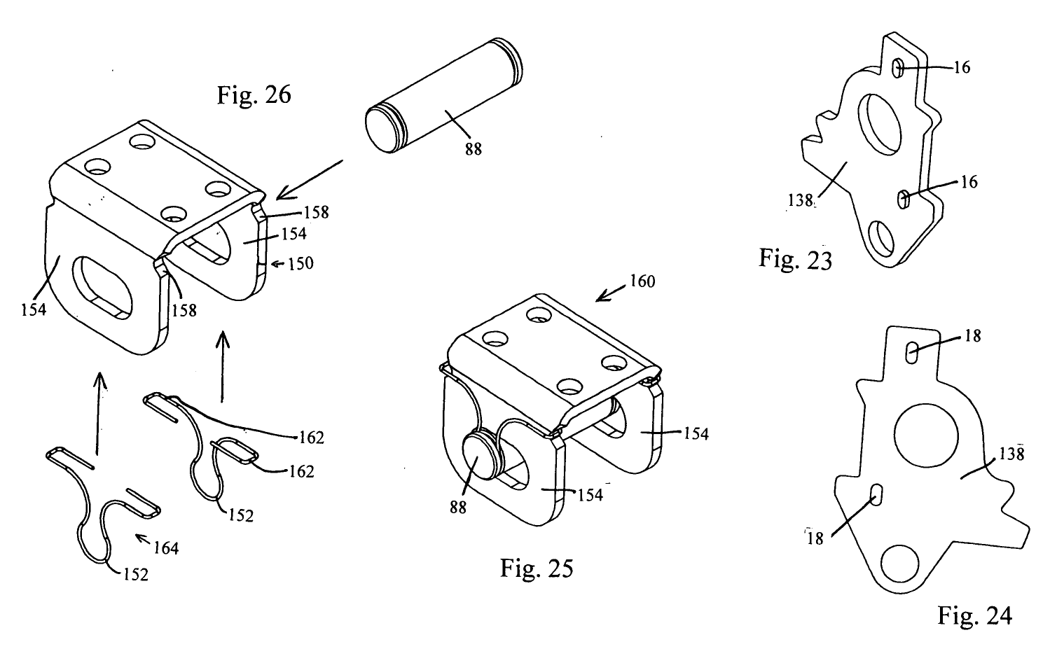

The housing 104 as seen in FIG. 18 has notch 2 for engagement with a striker 88 and also has apertures 4 and 6 which receive pawl rivet 10 and actuator rivet 8. As seen in FIGS. 19 to 22 pawl 140 can be formed from striker engagement means 143 having striker engagement portion 89. Striker engagement means 143 has studs 12 which fit into depressions 14 of actuator engagement means 145. The studs 12 and depressions 14 make the arrangement of the pawl 140 such that the pawl 140 can be mounted on either of apertures 4 and 6 of the housing 104 thereby yielding either a right hand or left hand version of the latch 100. Accordingly, stud 16 on the striker engagement means 143 can be fit up to depression 18 on the actuator engagement means 145. Similarly, actuator 138 can be formed from two plates 188 as seen in FIG. 23 and 24 in which stud 20 on first actuator piece 138 fits into depression 22 on second actuator piece 138.

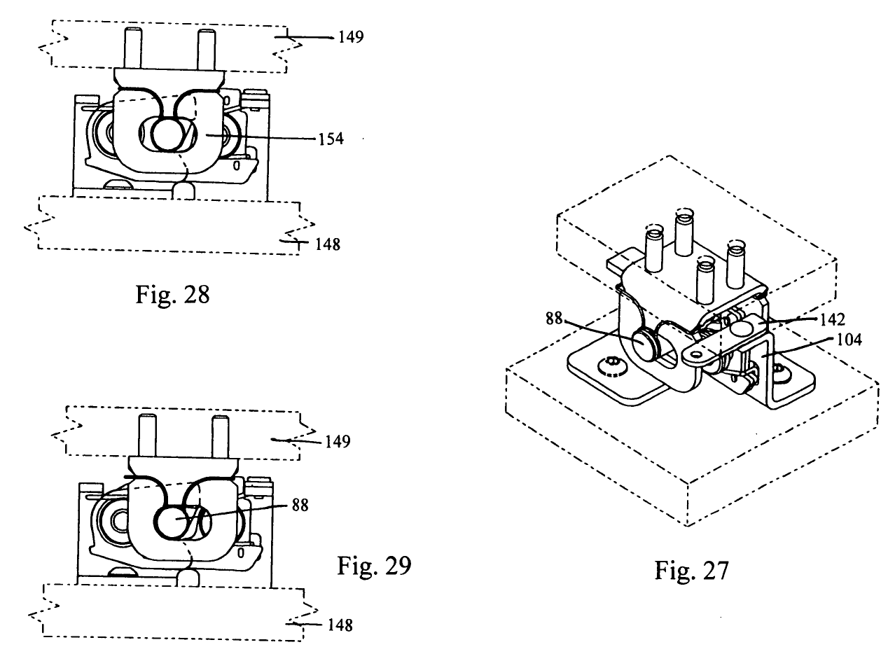

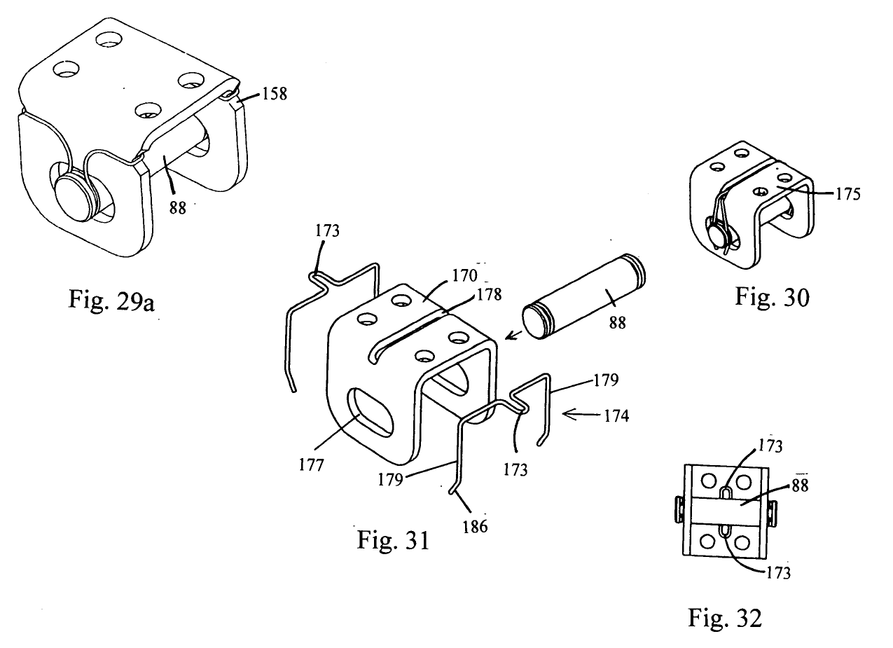

As seen in FIGS. 25 to 29, the present invention also includes a striker assembly 160 which is formed from striker 88, a striker housing 150 having a striker housing top portion 171 having sidewalls 154. The top of each sidewall 154 has sidewall notch 158 in which spring loops 162 of first striker housing spring 164 engage. First striker housing spring 164 has a spring portion 152 for engaging a surface 90 of the striker 88 and maintaining the striker 88 in a centering position in the sidewall aperatures 177 of the two sidewalls 154 whereby the floating first striker housing spring 164 permits movement of the striker 88 in the two sidewall aperatures 177 upon impact of the pawl 140 with the striker. As seen in FIGS. 25, 27 and 29, the striker assembly 160 can accommodate a striker 88 in an off-center position and by the biasing forces of first striker housing spring 164 return the striker 88 to a centering position as seen in FIG. 29a. As shown in FIGS. 28 and 29 the striker assembly 160 can fasten first panel 148 to second panel 149.

Another embodiment of the self-centering striker latch assembly of the present invention is shown in FIGS. 30-32 in which striker housing 170 has a portion of second striker housing spring 174 inserted through striker housing slot 178 such that u-shaped portion 173 is bent up against the bottom of the striker housing top portion 175, thus biasing striker 88 into a centering position in sidewall aperature 177. Second striker housing spring 174 can have a bend 186 proximate each end of spring legs 179 such that the striker 88 engages spring legs 179 at a position between the bend 186 and the end of said spring legs 179 and at a position between the bend 186 and the u-shaped portion 173.

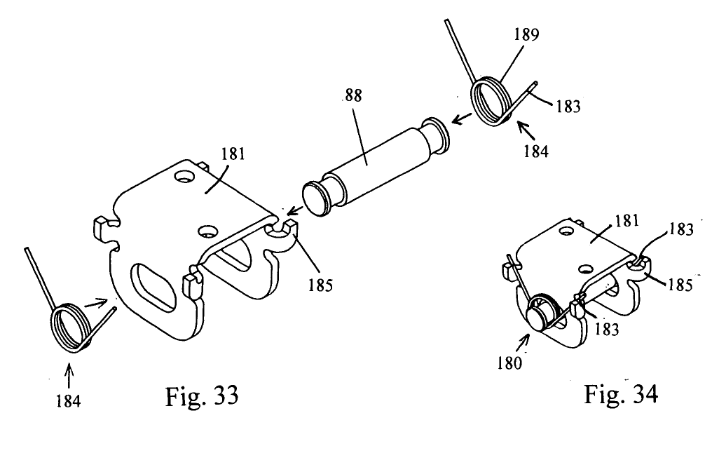

As shown in yet another embodiment shown in FIGS. 33 and 34, third striker housing spring 184 has spring legs 183 which are biased against striker housing protuberance 185 such that striker assembly 180 biases the striker 88 in a centering position in striker housing 181. Third striker housing spring 184 has a coil portion 189 for engaging a surface of the striker 88 outside of the housing and maintaining the striker 88 in a centering position.

It will be apparent to those skilled in the art that various modifications can be made to the latch of the present invention without departing from the scope and spirit of the invention, and it is intended that the present invention cover modifications and variations of the latch which are within the scope of the appended claims and their equivalents.

1. A latch for releasably securing a first member in a closed configuration relative to a second member, said second member having a striker in a fixed positional relationship therewith, the latch comprising:
a housing;
a pawl pivotally attached to said housing and being movable between a closed position and an open position, said pawl being provided with a biasing means for biasing the pawl toward the open position, said pawl having a pawl engaging means and a striker engaging means for engaging the striker, said striker engaging means being dimensioned and configured to sweep an arc which extends further out from an axis about which said pawl pivots when said pawl is pivoted than an arc which is swept by said pawl engagement means when said pawl is pivoted;
an actuator pivotally attached to said housing movable between a jaw-releasing position and a jaw-retaining position, said actuator being provided with a biasing means for biasing the actuator toward the jaw-retaining position, said actuator having an actuator engaging means for engaging said pawl engaging means such that said actuator is pivoted by said pawl upon pivoting of said pawl to the closed position,
wherein when said pawl impacts the striker during closing of the first and second members together, said pawl is moved to the closed position and said striker engaging means retains said pawl in the closed position, and wherein pivoting of said actuator means allows said biasing means to rotate said pawl to the open position to thereby permit the latch to be disengaged from the striker.

2. The latch of claim 1 further comprising a trigger means, said trigger means being dimensioned and configured such that pivoting of said trigger means pivots said actuator means so as to permit the pawl to rotate to the open position.

3. The latch according to claim 1 wherein said pawl biasing means is a pawl spring.

4. The latch according to claim 1 wherein said actuator biasing means is an actuator spring.

5. The latch according to claim 1 wherein said pawl engaging means and said actuator engaging means are dimensioned and configured to permit said pawl and said actuator to be maintained in an intermediate position in which the striker engages said pawl and said actuator engages said actuator.

6. The latch according to claim 5 wherein the pawl engaging means has a first pawl engaging means tooth and an adjacent second pawl engaging means tooth, and the actuator engaging means has a first actuator engaging means tooth and an adjacent second actuator engaging means tooth wherein when said pawl and said actuator are in the intermediate position said first pawl engaging means tooth engages between said first actuator engaging means tooth and said second actuator engaging means tooth.

7. The latch according to claim 6 wherein said housing has an aperture and said actuator comprises a first plate and an opposed second plate, said first plate and second plate being adjacent to each other and in direct contact with one another such that said actuator has two major exterior surfaces and one of said two major exterior surfaces faces said housing.

8. The latch according to claim 7 wherein the actuator biasing means is a spring having a leg at each of two ends of said spring and one of said legs extends into said aperture in said housing.

9. The latch according to claim 7 wherein one of said first plate and said second plate has a depression and the other of said first plate and second plate has a stud dimensioned and configured for engagement with said depression so as to maintain said first plate and said second plate fixed relative to each other.

10. The latch according to claim 7 wherein the housing has a u-shaped notch for receiving the striker.

11. The latch according to claim 6 wherein said striker engaging means is a first plate and said actuator engaging means is a second plate, said first plate and second plate being in direct contact with each other and fixed relative to each other.

12. The latch according to claim 1 further comprising a floating striker housing, said floating striker housing having:
a top portion having two opposite ends;
an opposed side wall extending from each opposite end of said top portion, each of said sidewalls having an aperture for receiving the striker,
two sidewall notches on the periphery of each of said sidewalls, each sidewall notch being located proximate the junction of each of said sidewalls with said top portion of said floating striker housing; and
two floating striker housing springs, each floating striker housing spring having two spring legs which form spring loops for being received and engaged in each corresponding sidewall notch of each of said two sidewalls and each floating striker housing spring having a spring portion for engaging a surface of the striker and maintaining the striker in a centering position in said apertures of said two sidewalls whereby said floating striker housing spring permits movement of the striker in said two sidewall apertures upon impact of said pawl with the striker.

13. The latch according to claim 1 further comprising a floating striker housing, said floating striker housing having:
a top portion having two opposite ends;
an opposed side wall extending from each opposite end of said top portion, each of said sidewalls having an aperture for receiving the striker,
a top portion slot which extends through the top portion and which extends between the two opposed sidewalls, and
two floating striker housing springs, each floating striker housing spring having a u-shaped portion which is biased against an interior face of the top portion, said floating striker housing spring having two spring legs which engaging a surface of the striker outside of the floating striker housing and said spring legs maintaining the striker in a centering position in said apertures of said two sidewalls whereby said floating striker housing spring permits movement of the striker in said two sidewall apertures upon impact of said pawl with the striker.

14. The latch according to claim 13 wherein each spring leg has a bend proximate an end of said spring leg such that the striker engages said spring leg at a position between said bend and said end of said spring leg and at a position between said bend and said u-shaped portion.

15. The latch according to claim 1 further comprising a floating striker housing, said floating striker housing having:
a top portion having two opposite ends;
an opposed side wall extending from each opposite end of said top portion, each of said sidewalls having an aperture for receiving the striker,
two sidewall protuberances on the periphery of each of said sidewalls, each sidewall protuberance being located proximate the junction of each of said sidewalls with said top portion of said floating striker housing; and
two floating striker housing springs, each floating striker housing spring having two spring legs for being received and engaged in each corresponding sidewall protuberance of each of said two sidewalls and each floating striker housing spring having a coil portion for engaging a surface of the striker outside of the housing and maintaining the striker in a centering position in said apertures of said two sidewalls whereby said floating striker housing spring permits movement of the striker in said two sidewall apertures upon impact of said pawl with the striker.
